(19) United States
(12) Patent Application Publication
(10) Pub. No.: US 2008/0283239 A1
(43) Pub. Date: Nov. 20, 2008

(54) WELL SCREEN WITH DIFFUSION LAYER

(75) Inventors: Michael Langlais, Bartlesville, OK (US); Rick Kenney, Longwood, FL (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 11/829,449

(22) Filed: Jul. 27, 2007

Related U.S. Application Data
(60) Provisional application No. 60/917,749, filed on May 14, 2007.

(51) Int. Cl. E03B 3/18; B32B 37/04; B32B 37/12

(52) U.S. Cl. 166/230; 156/155; 156/182

(57) ABSTRACT

A technique is provided for creating a well screen having a diffusion layer affixed to a filter medium to create a coherent structure. The diffusion layer is formed as a structure that freely allows movement of fluid, while the filtering medium is designed to filter particulates of a specific size. The diffusion layer is affixed to the filtering medium along a filtering medium surface to greatly improve collapse and burst resistance of the filtering medium. One method of affixing comprises bonding the diffusion layer to the filtering medium via a sintering process.

### CROSS REFERENCE TO RELATED APPLICATION

This application claims priority to provisional application Ser. No. 60/917,749 filed May 14, 2007 (Attorney's Docket No. 68.0693).

### BACKGROUND

A variety of well screens are used in many well related applications. In fluid production applications, for example, well screens are used to filter particulates that would otherwise damage production pumps and related equipment. Generally, the filter medium is disposed around a base pipe having openings through which the desired production fluid is introduced into a fluid flow path within the base pipe. The filter medium may comprise a one or more mesh layers sized to filter the unwanted particulates.

During production, hydrocarbons passing through the filter medium require an open, non-restrictive flow path between the filter medium and the base pipe to facilitate fluid movement to the base pipe perforations. Such an open, non-restrictive flow path is provided by a spacer layer, sometimes referred to as a drainage layer. In various production operations, the production drawdown can be sufficient to collapse the filter medium onto the drainage layer. The collapsed filter medium is extruded into the drainage layer, thus closing off the drainage flow path and creating “hot spots” directly above base pipe perforations.

Additionally, the drainage layers, whether interior or exterior of the filter medium, require clearances to facilitate assembly and this compromises the performance of the filter medium under mechanical loads such as burst or collapse loads. Existing drainage layers also have posed other significant problems whether deployed along interior or exterior regions of the filter medium. For example, drainage layers typically are made from heavier gauge wire that can create many handling problems during installation of the drainage layer into the well screen. Additionally, the available drainage layers provide little protection for the filter medium and can even cause damage to the filter medium if not properly constructed and handled relative to the filter medium. Current drainage layers also fail to provide sufficient collapse and burst resistance.

### SUMMARY

In general, the present invention provides a system and method for creating a strong, easy-to-handle well screen in which a diffusion layer is affixed to a filter medium to create a coherent structure. In one example, the filtering medium is created from a wire mesh selected to filter particulates of a specific size. The corresponding diffusion layer is formed as a wire structure with its individual wires having a cross-section substantially larger than that of any wire contained within the filtering medium. The diffusion layer is affixed to the filtering medium along a filtering medium surface to create a coherent structure having great collapse and burst resistance. One method of affixing comprises bonding the diffusion layer to the filtering medium via a sintering process.

### BRIEF DESCRIPTION OF THE DRAWINGS

Certain embodiments of the invention will hereafter be described with reference to the accompanying drawings, wherein like reference numerals denote like elements, and:

FIG. 1 is a cross-sectional view of a section of a well screen, according to an embodiment of the present invention;

FIG. 2 is a cross-sectional view of another embodiment of the well screen, according to an alternate embodiment of the present invention;

FIG. 3 is a front elevation view of a well screen positioned in a wellbore and showing partially broken away sections of well screen, according to an embodiment of the present invention;

FIG. 4 is an illustration of a portion of a diffusion layer used in the well screen, according to an embodiment of the present invention;

FIG. 5 is an illustration of a portion of another embodiment of the diffusion layer used in the well screen, according to an alternate embodiment of the present invention;

FIG. 6 is an illustration of a portion of another embodiment of the diffusion layer used in the well screen, according to an alternate embodiment of the present invention;

FIG. 7 is an illustration of a portion of another embodiment of the diffusion layer used in the well screen, according to an alternate embodiment of the present invention;

FIG. 8 is a cross-sectional view of the diffusion layer bonded to a filtering medium to create a coherent structure, according to an embodiment of the present invention;

FIG. 9 is a cross-sectional view similar to FIG. 8 but showing diffusion layer wire having a different cross-section, according to an embodiment of the present invention;

FIG. 10 is a cross-sectional view similar to FIG. 8 but showing diffusion layer wire having a different cross-section, according to an embodiment of the present invention; and

FIG. 11 is a cross-sectional view similar to FIG. 8 but showing diffusion layer wire having a different cross-section, according to an embodiment of the present invention.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a well screen system utilized in a wellbore. The well screen system comprises a filtering medium to filter particulates and one or more diffusion layers providing a lateral flow pore geometry that reduces pressure drop when deployed along a surface of the filtering medium. The diffusion layer is able to diffuse, i.e. suppress, the fluid velocity entering the filtering medium by maintaining pore geometry and open area under mechanical loads. Lower velocities reduce the potential for erosion.

The diffusion layer is bonded to the filtering medium to create a coherent structure that provides strong structural integrity and great collapse and burst resistance. The diffusion layer may be bonded to the filtering medium along its surface by, for example, sintering. In addition to improving the structural integrity and collapse/burst resistance of the filtering medium, the coherent structure also provides for easier handling and assembly into the overall well screen system. The coherent structure does not allow the filtering medium to be punctured, for example, which could cause premature failure. The coherent structure removes the need to design clearances into the well screen for assembly purposes which, in turn, minimizes or eliminates the occurrence of ridgelines or crimps in the filtering medium under collapse conditions. Additionally, the attached diffusion layer or layers can facilitate insertion of the coherent structure along adjacent tubulars, such as internal base pipes or external shrouds.

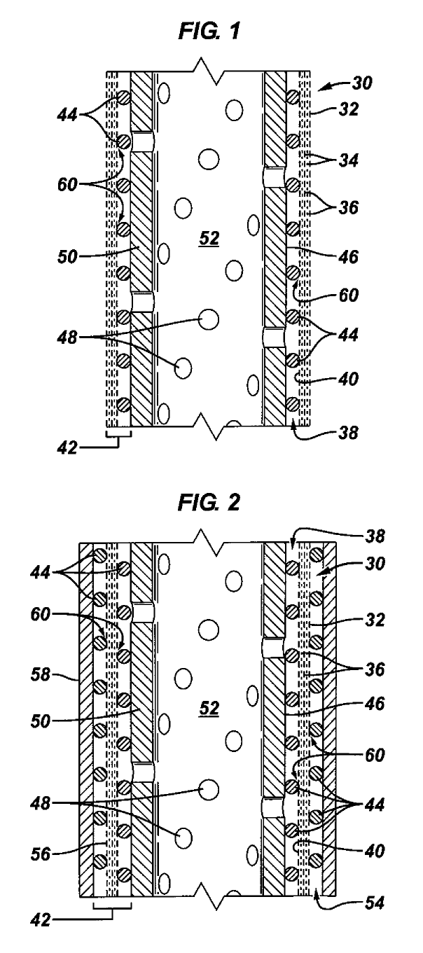

Referring generally to FIG. 1, a well screen 30 is illustrated as comprising a filtering medium 32 constructed to filter particulates of a selected size. The filtering medium 32 may be formed as a mesh having one or more layers 34 formed of wire 36. Well screen 30 also comprises a diffusion layer 38 positioned along a surface of filtering medium 32. In the embodiment illustrated in FIG. 1, diffusion layer 38 is positioned along an interior surface 40 of filtering medium 32. Furthermore, diffusion layer 38 is affixed to filtering medium 32 to create a coherent structure 42. For example, diffusion layer 38 may comprise wire 44 that is sintered or otherwise bonded to filtering medium 32 along interior surface 40 throughout all or a substantial portion of the filtering medium.

The coherent structure 42 has great strength, and the bonding of diffusion layer 38 to filtering medium 32 along all or a substantial portion of filtering medium 32 greatly increases both the collapse and burst resistance of the filtering medium. The diffusion layer 38 basically provides a space between the filtering medium and an adjacent tubular member. In the embodiment of FIG. 1, for example, the diffusion layer 38 is disposed between filtering medium 32 and an internal base pipe 46. Base pipe 46 has a plurality of openings 48 which may be positioned to extend generally radially through a tubular wall 50 that defines the base pipe. The openings 48 may be, for example, directly below filtering medium 32 or spaced from the filtering medium. Diffusion layer 38 and filtering medium 32 also are tubular in shape and circumferentially disposed about base pipe 46. The space created by diffusion layer 38 between filtering medium 32 and base pipe 46 accommodates fluid flow in a variety of directions along the filtering medium and the base pipe. Accordingly, if regions of the filtering medium 32 become plugged or blocked, the fluid flowing through other parts of the filtering medium can flow along diffusion layer 38 and enter an interior 52 of base pipe 46 through openings 48 positioned radially below the blocked portion of the filtering medium. The use of diffusion layer 38 is thus able to facilitate flow into base pipe 46 even if a region or regions of the filtering medium 32 become plugged with sand or other particulates.

Referring generally to FIG. 2, another embodiment of well screen 30 is illustrated. In this embodiment, a second diffusion layer 54 is positioned adjacent an exterior surface 56 of filtering medium 32 such that second diffusion layer 54 is circumferentially disposed about filtering medium 32. Second diffusion layer 54 also may be affixed to filtering medium 32 to create a coherent structure 42 having the beneficial properties described above. Diffusion layer 38 and the second diffusion layer 54 can both be bonded to filtering medium 32, or coherent structure 42 may be formed with only filtering medium 32 and the second or external diffusion layer 54. In the embodiment illustrated, second diffusion layer 54 is positioned between filtering medium 32 and an outlying tubular member 58, such as a shroud. Diffusion layer 38 and/or second diffusion layer 54 are bonded, e.g. sintered, to filtering medium 32 at multiple contact regions 60 across filtering medium surfaces 40 and/or 56, respectively.

The formation of the filtering medium and the one or more diffusion layers into coherent structure 42 facilitates the construction and handling of the filtering medium and diffusion layer or layers. However, affixing the diffusion layer to the filtering medium also reduces or illuminates friction and/or snagging of the diffusion layer with respect to adjacent tubular members, such as external shroud 58. Formation of coherent structure 42 also can minimize the outside diameter of the overall well screen product. These characteristics further enhance the ability to easily construct a variety of well screens 30.

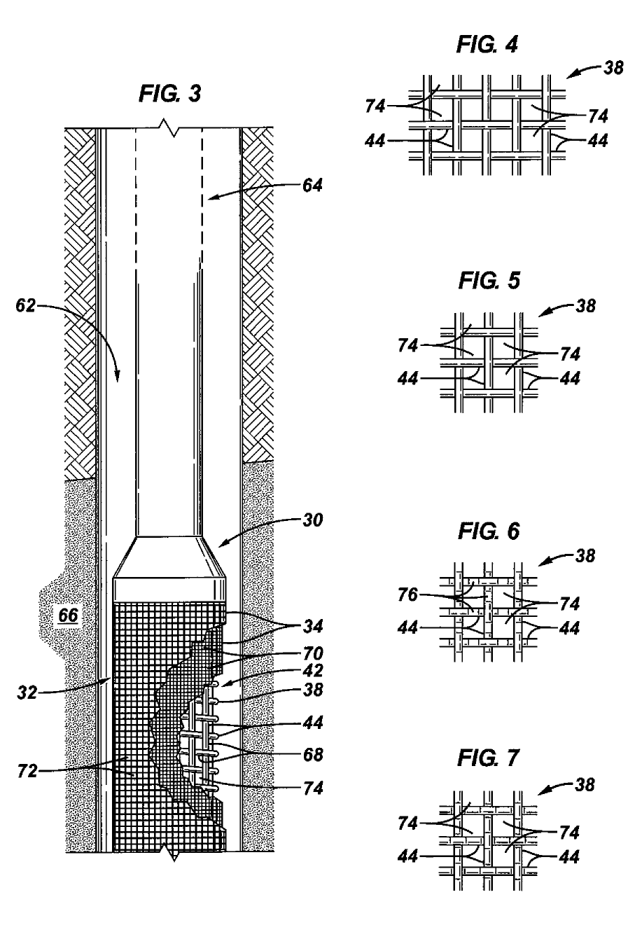

The exact structure of filtering medium 32 and diffusion layers 38, 54 can vary from one application to another. In FIG. 3, for example, one embodiment of well screen assembly 30 is illustrated as deployed in a wellbore 62 as part of an overall completion assembly 64. Wellbore 62 is drilled into a geological formation 66 that contains, for example, desirable production fluids, such as petroleum or other fluids. A portion of the well screen assembly 30 is illustrated as broken away to expose diffusion layer 38 deployed between base pipe 46 and filtering medium 32. In this embodiment, diffusion layer 38 is formed by wire 44 arranged in a crisscross pattern 68. The crisscross pattern 68 may have wire 44 woven in warp and weft directions with the wire running in the warp and weft directions having either the same or dissimilar diameters, respectively. Generally, the warp direction or warp wire is the continuous wire dispersed from a spool, and the weft direction or weft wire is the shoot wire or cross wire that extends across the warp wire. The number of wires can differ in warp as compared to weft directions. More wires in the circumferential orientation than the axial orientation increases hoop strength and/or burst resistance in, for example, the outer diffusion layer. The use of larger circumferential wires relative to axial wires also increases hoop strength and/or burst resistance.

Referring to FIG. 3, the embodiment of filtering medium 32 is illustrated as having a plurality of layers 34 formed as a wire mesh. By way of example, each mesh layer may be formed of wire having similar diameters. However, the mesh layers 34 also can be formed of wire having dissimilar diameters and dissimilarly sized openings, such as small openings 70 of one mesh layer and larger openings 72 of another mesh layer of filtering medium 32. The one or more layers of filtering medium 32 cooperate to filter particulates of a desired size before those particulates can move into the interior of well screen 30.

The diffusion layer 38 is a non-filtering layer designed to provide structural support while allowing the free flow of fluid. The crisscross pattern 68 of either diffusion layer has substantially larger openings 74 formed by the crisscrossing wire 44. Additionally, the wire 44 is a structural wire that supports filtering medium 32 when the diffusion layer 38 is affixed to the filtering medium by, for example, sintering. Generally, the smallest wire utilized in forming the diffusion layers is at least two times larger in cross-section than the largest wire used in forming the mesh layers of filtering medium 32. By way of example, the diffusion layer wires have a diameter two to four times greater than the diameter of the largest wire diameter found in the filtering medium 32.

Diffusion layer 38 and/or diffusion layer 54 can be constructed in a variety of configurations. One configuration that works well is a twill herringbone configuration or pattern. Many types of applications can utilize a coarse woven configuration; however other wire patterns can be used. Additionally, structural materials other than wire also can be used in constructing each diffusion layer. Examples of diffusion layers having crisscross pattern 68 formed into a woven structure are illustrated in FIGS. 4-7.

In FIG. 4, for example, diffusion layer 38, 54 has wire 44 formed into a square, plain weave pattern. One specific example of a generally square weave pattern is illustrated in FIG. 5 as a single crimp weave pattern. Another alternate woven form is a double crimp weave in which the warp and weft wire sections have intermediate crimps 76 disposed between pairs of cross wires, as illustrated in FIG. 6. Another drainage layer embodiment utilizes a lock crimp weave pattern, as illustrated in FIG. 7. In this latter embodiment, the crisscrossed wire is pre-crimped in both the warp and weft directions to securely lock the wires together. A variety of other woven and non-woven patterns can be used in forming the structural diffusion layers 38 and/or 54. Regardless, the configuration of the diffusion layer enables bonding, e.g. sintering, of the diffusion layer to the filtering medium 32 at the multiple contact regions 60 along the filtering medium.

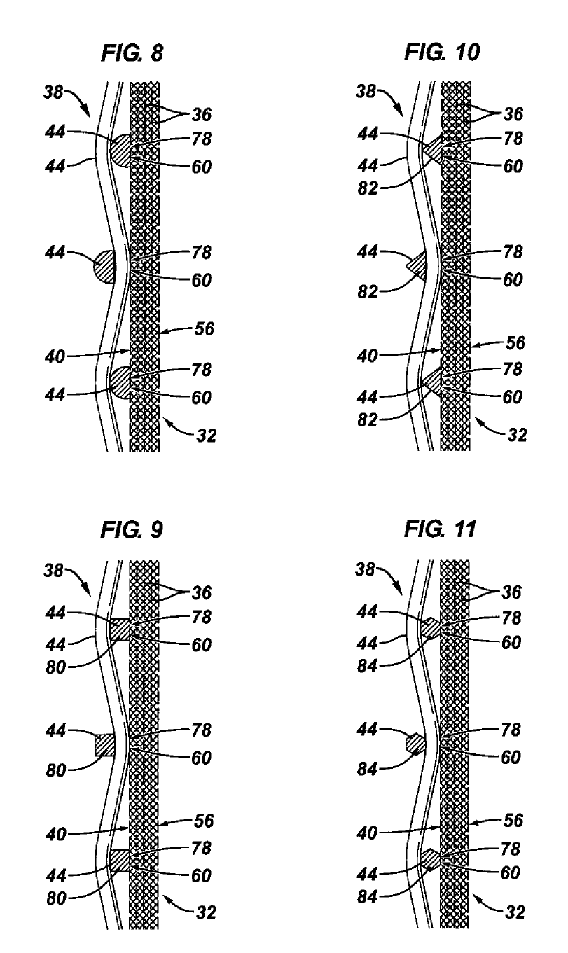

The structural integrity of the coherent structure 42 can be further enhanced by creating greater surface area at the contact regions 60 to enhance the bonding between the diffusion layer 38, 54 and the filtering medium 32. For example, greater surface area enables the creation of a stronger bond when the filtering medium and the diffusion layer are sintered together. One way of creating greater surface area is to form flat surface areas at contact regions 60. For example, the wire 44 used to create the diffusion layer, e.g. diffusion layer 38, can be formed with a flat surface or flat side 78, as illustrated in FIG. 8. The flat surface 78 is formed such that it is oriented toward filtering medium 32 when the diffusion layer and filtering medium are joined.

The flat surface 78 can naturally be created by selecting wire 44 having a cross-section with at least one flat surface oriented in the desired direction. For example, the diffusion layer 38, 54 can be formed with wire 44 having a generally rectangular, e.g. square, cross-section 80, as illustrated in FIG. 9. The wire 44 also can be selected with other cross-sectional configurations. In FIG. 10, for example, wire 44 is illustrated as having a triangular cross-section 82. The wire 44 also may have a hexagonal cross-section 84, as illustrated in FIG. 11, as well as a variety of other cross-sectional configurations that provide a flat side having greater surface area for bonding. The filtering medium 32 also may use wires of one shape running in a first direction and wires of a different shape running in a cross direction. The flat side of the wires can be used not only to facilitate bonding but also to affect flow area, flow characteristics, and mechanical characteristics.

The structure of the filtering medium as well as the diffusion layer or layers can be adjusted according to the desired production parameters and/or wellbore environment. The filtering medium and diffusion layer are readily formed as a coherent structure through sintering, however other techniques can be utilized in affixing the filtering medium and the one or more diffusion layers. Additionally, the coherent structure 42 can be used in a variety of well screens and with a variety of completion assemblies in fluid production and other types of well related operations.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A well screen, comprising:
a base pipe;
a wire mesh filtering medium circumferentially disposed about the base pipe; and
a diffusion layer dispose between the base pipe and the wire mesh filtering medium, the diffusion layer being formed by crisscrossing wire of sufficient diameter to create a diffusion area between the base pipe and the wire mesh filtering medium, the diffusion layer being sintered to the wire mesh filtering medium along a substantial portion of the wire mesh filtering medium.

2. The well screen as recited in claim 1, further comprising a second diffusion layer disposed on an opposite side of the wire mesh filtering medium relative to the base pipe, the second diffusion layer being sintered to the wire mesh filtering medium.

3. The well screen as recited in claim 1, wherein the base pipe has a plurality of radial openings.

4. The well screen as recited in claim 1, wherein the wire mesh filtering medium comprises a plurality of layers formed of different diameter wire.

5. The well screen as recited in claim 1, wherein the smallest diameter of the crisscrossing wire is at least two times larger than the largest diameter of the wire forming the wire mesh filtering medium.

6. The well screen as recited in claim 1, wherein the crisscrossing wire of the diffusion layer is formed as a woven diffusion layer.

7. The well screen as recited in claim 6, wherein the woven diffusion layer comprises wire of a given diameter running in a first direction and wire of a different diameter running in a second direction.

8. The well screen as recited in claim 6, wherein the woven diffusion layer comprises wire of a given cross-sectional shape running in a first direction and wire of a different cross-sectional shape running in a second direction.

9. The well screen as recited in claim 1, wherein at least a portion of the crisscrossing wire is formed with a generally flat surface oriented toward the wire mesh filtering medium to which it is sintered.

10. A well screen, comprising:
a filtering medium having wire formed into a mesh to filter a selected particulate size, the filtering medium being tubular in shape; and
a diffusion layer formed of structural wire having a cross-section substantially larger than that of the wire used to form the filtering medium, the diffusion layer being affixed to the filtering medium throughout the filtering medium to improve the collapse and burst resistance of the filtering medium.

11. The well screen as recited in claim 10, wherein the diffusion layer is affixed to the filtering medium via sintering.

12. The well screen as recited in claim 10, wherein the cross-section of the structural wire in the diffusion layer is at least twice the size of the cross-section of any wire in the filtering medium.

13. The well screen as recited in claim 10, wherein the diffusion layer has the structural wire woven into a cross mesh weave pattern.

14. The well screen as recited in claim 10, wherein the diffusion layer is affixed along an interior of the filtering medium.

15. The well screen as recited in claim 10, wherein the diffusion layer is affixed along an exterior of the filtering medium.

16. The well screen as recited in claim 10, wherein the structural wire of the diffusion layer has a flat portion to provide greater surface area for bonding with the filtering medium.

17. A method of forming a well screen, comprising:
forming a tubular filtering medium;
constructing a non-filtering diffusion layer; and
bonding the non-filtering diffusion layer to the tubular filter medium along a surface of the tubular filtering medium to provide support for the entire tubular filtering medium.

18. The method as recited in claim 17, further comprising positioning the non-filtering diffusion layer inside the tubular filtering medium; and locating a base pipe within the non-filtering diffusion layer.

19. The method as recited in claim 17, wherein constructing comprises constructing the non-filtering diffusion layer in a cross mesh weave pattern.

20. The method as recited in claim 17, wherein constructing comprises constructing the non-filtering diffusion layer with crisscrossing wire having a flat side to facilitate bonding to the tubular filtering medium.

21. The method as recited in claim 17, wherein bonding comprises sintering across the surface of the tubular filtering medium.

22. The method as recited in claim 17, wherein forming comprises forming the tubular filtering medium with wires of differing diameters.

23. The method as recited in claim 22, wherein constructing comprises constructing the non-filtering diffusion layer with crisscrossing wire having a smallest diameter at least two times greater than the largest diameter of the wire forming the tubular filtering medium.

24. A method of forming a well screen, comprising:
positioning a wire mesh filtering medium around a base pipe;
deploying a diffusion layer between the base pipe and the filtering medium; and
sintering the diffusion layer along the entire wire mesh filtering medium.

25. The method as recited in claim 24, further comprising forming the diffusion layer with wire having one or more flat regions to provide greater surface area for facilitating sintering of the diffusion layer to the wire mesh filtering medium.

26. (canceled)

27. (canceled)

28. (canceled)
